(19) United States
(12) Patent Application Publication
(10) Pub. No.: US 2018/0025816 A1
(43) Pub. Date: Jan. 25, 2018

(54) PROCESS FOR MANUFACTURING A TWISTED PAIR OF WIRES

(71) Applicant: Champlain Cable Corporation, Colchester, VT (US)

(72) Inventors: Futsum G. Woldesus, Essex Junction, VT (US); Richard Scott Antic, South Burlington, VT (US); Solomon Mulugeta, Tolland, CT (US); Gary Paul Newton, Colchester, VT (US)

(73) Assignee: Champlain Cable Corporation, Colchester, VT (US)

(21) Appl. No.: 15/214,724

(22) Filed: Jul. 20, 2016

(51) Int. Cl. H01B 13/14; H01B 13/22

(52) U.S. Cl. CPC H01B 13/145; H01B 13/22

(57) ABSTRACT

A method of forming a twisted pair of wires for use with Ethernet-based networks. At least two wires are extruded with a cross-linked polyolefin insulating composition marketed under the registered trademark, EXRAD®. The wires are twisted together with a consistent lay length to form a cable. The cable is irradiated to become thermoset. Electrical properties of the extruded wire are controlled during the extrusion step and concentricity of the wire and surrounding insulation is also monitored and controlled. The cable can be jacketed to provide greater mechanical protection.

### FIELD OF THE INVENTION

This invention relates to wires and cables and, more particularly, to a method of forming a twisted pair of wires for use in Ethernet-based networks.

### BACKGROUND OF THE INVENTION

The Ethernet is a family of computer networking technologies commercially introduced in 1980 and first standardized in 1983 as IEEE 802.3, which is a working group and a collection of IEEE standards produced by the working group defining the physical layer and data link layer's media access control (MAC) of wired Ethernet. Physical connections are made between nodes and/or infrastructure devices (hubs, switches, routers) by various types of copper or fiber cable. This is generally a local area network technology with some wide area network applications. Most recently, the automotive industry has adopted Ethernet technology to allow multiple in-vehicle systems such as cameras and onboard diagnostics to simultaneously access information over a single, unshielded twisted pair cable.

Ethernet variants use twisted pair and fiber optic links in conjunction with hubs or switches. Ethernet data transfer rates have increased from the original 2.94 megabits per second (Mbit/s) to approximately 100 gigabits per second (Gbit/s), with 400 Gbit/s expected by late 2017.

Systems communicating over Ethernet divide a stream of data into shorter pieces called frames. Each frame contains source and destination addresses, and error-checking data so that damaged frames can be detected and discarded; most often, higher-layer protocols trigger retransmission of lost frames.

### DESCRIPTION OF RELATED ART

U.S. Pat. No. 4,043,362 issued to Senior, et al. for CUTTING AND INSULATION STRIPPING APPARATUS FOR TWISTED WIRE PAIR issued on Aug. 23, 1977, describes apparatus for cutting and insulation stripping of twisted conductor wire pairs comprising a wire feed mechanism for feeding predetermined lengths of twisted wire pairs into clamping mechanism. This reference provides a rudimentary description of a twisted pair of wires forming a cable.

### SUMMARY OF THE INVENTION

In accordance with the present invention, there is provided a method of forming a twisted pair of wires for use with Ethernet-based networks. At least two wires are extruded with a cross-linked polyolefin insulating composition marketed under the trademark, EXRAD®, and described in U.S. Pat. No. 5,545,853, assigned to the present assignee. The wires are twisted together with a consistent lay length to form a cable. The cable insulation is thermoplastic initially and then irradiated to be thermoset. Electrical properties of the extruded wire are controlled during the extrusion step and concentricity of the wire insulation and capacitance is also monitored and controlled. The cable can be jacketed to provide greater mechanical protection.

It is therefore an object of the invention to provide a process for forming a cable from a twisted pair of wires.

It is a further object of the present invention to provide a process for forming a cable for use in Ethernet-based networks.

It is a further object of the present invention to provide a process for forming a cable specifically for use in the automotive industry.

It is a further object of the present invention to provide a thermoset, irradiation cross-linked cable for use in automotive, Ethernet-based networks.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a perspective view of two individual stranded or solid conductors insulated with an insulative composition accordance with the present invention; and

FIG. 2 is a schematic view of the two wires shown in FIG. 1 having a surrounding jacket.

Like reference numerals refer to like parts throughout the several views of the drawings.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

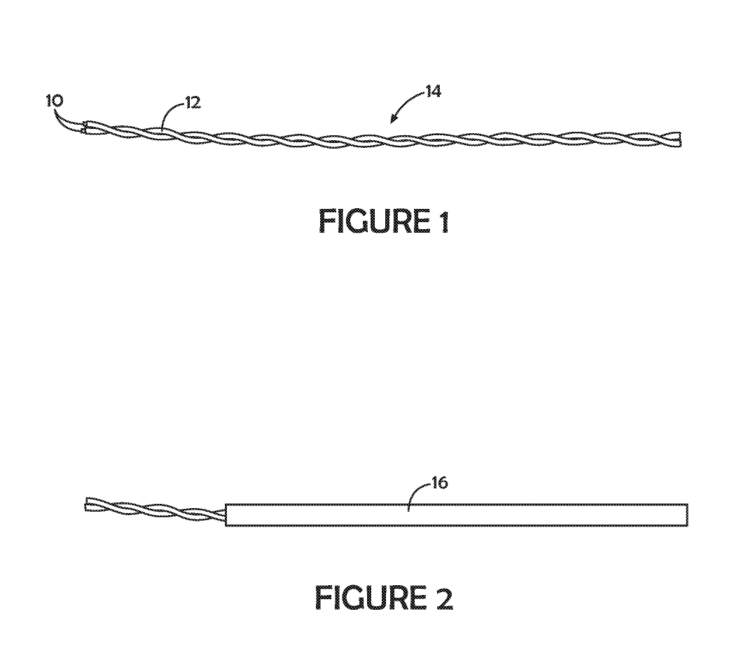

Referring now to FIG. 1, the inventive process begins with individual stranded or solid conductors 10 insulated with a composition 12 created by the present assignee and marketed under the trademark, DATARAD™. The wire 10 is extruded and insulated with the EXRAD composition. This insulation material 12 is an EXRAD compound that meets the ISO 6722-1 and SAE J1128 performance requirements.

Electrical properties of the insulated wire (e.g., capacitance and resistance) are controlled, as is well known in the art, during the extrusion step. Moreover, concentricity of the wire 10 and surrounding insulation 12 is also monitored and controlled, also as well known in the art.

Once the wire 10 and insulation 12 are extruded, the two insulated wires are twisted together with a consistent lay length to form a cable 14.

The twisted pair of wires 14 is then thermoset using electron beam accelerator also known as e-beam at room temperature. The twisted pair 14 is then irradiated by an electron beam using a range of dosage from 5 Mrad to 15 Mrad to cross-link the insulation.

After the wire and insulation 10 are cross-linked, the twisted pair 14 retains the twist form when the ends are cut. This twisted cable 14 can be used unjacketed. Alternatively, referring to FIG. 2, the cable 14 can be jacketed 16 to provide greater mechanical protection.

The final product is a cable that is useful for systems that allow multiple in-vehicle systems such as cameras and onboard diagnostics to simultaneously access information over a single, unshielded twisted pair cable. The cable meets the stringent electrical requirement of the automotive industry such as BroadR-Reach, IEEE 802.3, and SAE J3117 requirements.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention. For example, parameters of conductor sizes and irradiation dosage can all be varied as required. Moreover, although two solid conductor have been shown in the aforementioned description, it should be understood that more than two conductors can be twisted together, and the conductors themselves can be individual strands.

Having thus described the invention, what is desired to be protected by Letters Patent is presented in the subsequently appended claims.

What is claimed is:

1. A method of forming a twisted pair of wires for use with Ethernet-based networks, the steps comprising:
a) extruding at least two wires with a cross-linked polyolefin insulating composition;
b) twisting together said wires with a consistent lay length to form a cable;
c) irradiating said cable; and
d) thermosetting said cable.

2. The method of forming a twisted pair of wires for use with Ethernet-based networks in accordance with claim 1, wherein electrical properties of said extruded wire are controlled during said extrusion step (a) and twisting step (b).

3. The method of forming a twisted pair of wires for use with Ethernet-based networks in accordance with claim 1, further comprising monitoring and controlling concentricity of said wire and surrounding insulation during said extrusion step (a).

4. The method of forming a twisted pair of wires for use with Ethernet-based networks in accordance with claim 1, wherein said irradiation step (c) is performed by an electron beam using a dosage range from 5 Mrad to 15 Mrad to cross-link the insulation.

5. The method of forming a twisted pair of wires for use with Ethernet-based networks in accordance with claim 1, the steps further comprising jacketing said cable to provide greater mechanical protection.

6. The method of forming a twisted pair of wires for use with Ethernet-based networks in accordance with claim 1, wherein said insulating composition comprises a polyolefin based polymer compound.
